(19) United States
(12) Patent Application Publication
(10) Pub. No.: US 2019/0241723 A1
(43) Pub. Date: Aug. 8, 2019

(54) METHOD FOR PRODUCING TREAD RUBBER MEMBER AND TIRE PRODUCTION METHOD

(71) Applicant: Toyo Tire Corporation, Itami-shi, Hyogo (JP)

(72) Inventor: Hiroyuki Takahashi, Itami-shi (JP)

(73) Assignee: Toyo Tire Corporation, Itami-shi, Hyogo (JP)

(21) Appl. No.: 16/331,804

(22) PCT Filed: Sep. 7, 2017
(86) PCT No.: PCT/JP2017/032218

§ 371 Date: Mar. 8, 2019

(30) Foreign Application Priority Data
Oct. 14, 2016 (JP) 2016-202905

(51) Int. Cl. C08L 9/06; C08J 3/20; B60C 1/00; B60C 11/00

(52) U.S. Cl. CPC C08L 9/06; C08J 3/203; C08L 2205/03; B60C 11/0008; C08L 2205/025; B60C 1/0016

(57) ABSTRACT

Provided are a method for producing a tread rubber member that can improve low heat generation properties while maintaining workability and tear resistance, and a tire production method. A method for producing a tread rubber member, having a step for kneading a diene rubber, carbon black, a compound represented by the following formula (1) (in the formula, R¹ and R² represent a hydrogen atom, an alkyl group, an alkenyl group or an alkynyl group, and M⁺, is Na⁺, K⁺ or Li⁺) and zinc flower, and a step for adding silica to the kneaded product obtained in the above step, followed by kneading.

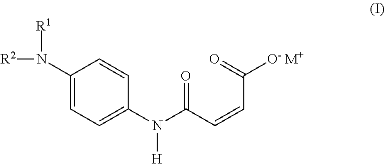

### TECHNICAL FIELD

The present invention relates to a method for producing a tread rubber member and a tire production method.

### TECHNICAL BACKGROUND

In recent years, demand for low heat generation properties to automobiles is increasing and a rubber member having excellent low heat generation properties is desired to be provided.

Carbon black is widely used as filler for a rubber composition for a tire in that reinforcing properties and abrasion resistance are good. In case where low heat generation properties of the composition comprising carbon black are improved, a method of using carbon black having large particle diameter and a method of adding silica in place of a part of carbon black are considered.

It is known to add (2Z)-4-[(4-aminophenyl)amino]-4-oxo-2-butenoic acid salt as an amine compound in order to improve low heat generation properties of a rubber composition (see Patent Documents 1 and 2).

### PRIOR ART DOCUMENTS

### Patent Document

Patent Document 1: JP-A-2014-95013
Patent Document 2: JP-A-2014-95014

### SUMMARY OF THE INVENTION

### Problems that the Invention is to Solve

However, low heat generation properties can be improved by improving dispersibility of carbon black by adding the amine compound, but tear resistance was sometimes deteriorated.

Furthermore, the amine compound bonds carbon black to a diene rubber. Therefore, when a diene rubber, carbon black and the amine compound are kneaded together, there was the problem that a viscosity increases and workability is deteriorated.

Furthermore, in case where in addition of the amine compound, silica is added in place of a part of carbon black in order to improve low heat generation properties, silica adsorbs the amine compound and disturbs the reaction between the amine compound and the carbon black. As a result, there was a case that the effect by the amine compound is not sufficiently obtained.

In view of the above, the present invention has an object to provide a method for producing a tread rubber member that can improve low heat generation properties while maintaining workability and tear resistance when adding carbon black, a predetermined amine and silica, and a tire production method.

### Means for Solving the Problems

The method for producing a tread rubber member according to the present invention has a step for kneading a diene rubber, carbon black, a compound represented by the following formula (I) and zinc flower, and a step for adding silica to the kneaded product obtained in the above step, followed by kneading.

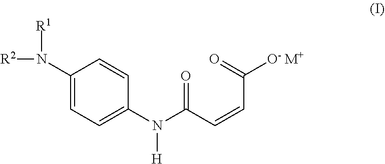

In the formula (I), R¹ and R² represent a hydrogen atom, an alkyl group having 1 to 20 carbon atoms, an alkenyl group having 1 to 20 carbon atoms or an alkynyl group having 1 to 20 carbon atoms, and R¹ and R² may be the same or different. M⁺ represents a sodium ion, a potassium ion or a lithium ion.

The production method can add 30 to 80 parts by mass of carbon black, 0.1 to 10 parts by mass of the compound represented by the formula (I), 1 to 10 parts by mass of zinc flower and 15 to 50 parts by mass of silica to 100 parts by mass of a diene rubber.

The production method can be that the content of a styrene-butadiene rubber in the diene rubber is 60 mass % or more.

A tire production method of the present invention comprises producing a tread rubber member by the method for producing a tread rubber member described above and producing a tire using the tread rubber member.

### Effects of the Invention

According to the present invention, a tread rubber member having improved low heat generation properties can be produced while maintaining and/or improving workability and tear resistance even when carbon black, the compound represented by the formula (I) and silica are added.

### MODE FOR CARRYING OUT THE INVENTION

Items relating to the embodiment of the present invention are described in detail below.

The method for producing a tread rubber member according to this embodiment has a step for kneading a diene rubber, carbon black, a compound represented by the following formula (I) and zinc flower, and a step for adding silica to the kneaded product obtained in the above step, followed by kneading.

In the method for producing a tread rubber member according to this embodiment, examples of the diene rubber used as a rubber component include natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber. Those diene rubbers can be used in one kind alone or as blends of two or more kinds. The rubber component is preferably natural rubber, butadiene rubber, styrene-butadiene rubber or blends of two or more kinds of those.

A blend rubber of styrene-butadiene rubber and other diene rubber is preferably used as the diene rubber, and a blend rubber of styrene-butadiene rubber, natural rubber (NR) and/or butadiene rubber (BR) is particularly preferably used.

The blending ratio of styrene-butadiene rubber in the diene rubber is not particularly limited, but is preferably 60 to 100 mass %.

The styrene-butadiene rubber may be unmodified SBR or modified SBR, may be solution polymerized SBR (S-SBR) or emulsion polymerized SBR (E-SBR), and appropriate combinations of those can be used. Thus, the styrene-butadiene rubber is not particularly limited.

The modified SBR may be an end-modified SBR having a functional group introduced in at least one end of a molecular chain of SBR, may be a main chain-modified SBR having a functional group introduced in the main chain and may be a main chain and end-modified SBR having functional groups introduced in the main chain and the end. Examples of the functional group include amino group, alkoxyl group, hydroxyl group, epoxy group and carboxyl group. Those groups may be introduced in one kind alone, respectively, or may be introduced by combining two or more kinds. The amino group is not only primary amino group, but may be secondary or tertiary amino group. Examples of the alkoxyl group (—OR, wherein R is an alkyl group) include methoxy group, ethoxy group, propoxy group and butoxy group. Specific example of the modified SBR includes “HPR350” (amine-modified SBR) manufactured by JSR Corporation.

The butadiene rubber (that is, polybutadiene rubber) is not particularly limited, and examples thereof include (A1) high cis-butadiene rubber, (A2) a syndiotactic crystal-containing butadiene rubber and (A3) a modified butadiene rubber. Those rubbers can be used in any one kind or as mixtures of two or more kinds.

The high cis-BR (A1) includes a butadiene rubber having a cis content (that is, cis-1,4 bond content) of 90 mass % or more (preferably 95 mass % or more), and specific examples thereof include a cobalt type butadiene rubber polymerized using a cobalt catalyst, a nickel type butadiene rubber polymerized using a nickel catalyst and a rare earth type butadiene rubber polymerized using a rare earth metal catalyst. The rare earth type butadiene rubber is preferably a neodymium type butadiene rubber polymerized using a neodymium catalyst, and the neodymium type butadiene rubber having a cis content of 96 mass % or more and a vinyl content (that is, 1,2-vinyl bond content) of less than 1.0 mass % (preferably 0.8 mass % or less) is preferably used. The use of the rare earth type butadiene rubber is advantageous to the improvement of low heat generation properties. The cis content and vinyl content are values calculated by an integration ratio of ¹H-NMR spectrum. Specific example of the cobalt type BR includes “UBEPOL BR” manufactured by Ube Industries, Ltd. Specific examples of the neodymium type BR include “BUNA CA22” and “BUNA CA25” manufactured by LAXESS.

Butadiene rubber that is a rubber resin composite comprising high cis-butadiene rubber as a matrix and syndiotactic 1,2-polybutadiene crystals (SPB) dispersed therein is used as the syndiotactic crystal-containing butadiene rubber (SPB-containing BR) (A2). The use of the SPB-containing BR is advantageous to the improvement of hardness. The SPB content in the SPB-containing BR is not particularly limited, and for example, may be 2.5 to 30 mass % and may be 10 to 20 mass %. The SPB content in the SPB-containing BR is obtained by measuring a boiling n-hexane insoluble content. Specific example of the SPB-containing BR includes “UBEPOL VCR” manufactured by Ube Industries, Ltd.

Examples of the modified BR (A3) include an amine-modified BR and a tin-modified BR. The use of the modified BR is advantageous to the improvement of low heat generation properties. The modified BR may be an end-modified BR having a functional group introduced in at least one end of a molecular chain of BR, may be a main chain-modified BR having a functional group introduced in the main chain and may be a main chain and end-modified BR having functional groups introduced in the main chain and the end. Specific example of the modified BR includes “BR 1250H” (amine end-modified BR) manufactured by Zeon Corporation.

In one embodiment, when the high cis-BR (A1) and the SPB-containing BR (A2) are used together, 100 parts by mass of the diene rubber may contain 40 to 70 parts by mass of NR and/or IR, 20 to 40 parts by mass of the high cis-BR and 10 to 30 parts by mass of the SPB-containing BR. When the high cis-BR (A1) and the modified BR (A3) are used together, 100 parts by mass of the diene rubber may contain 40 to 70 parts by mass of NR and/or IR, 20 to 40 parts by mass of the high cis-BR and 10 to 30 parts by mass of the modified BR. When the cobalt type BR and the neodymium type BR are used together as the high cis-BR (A1), 100 parts by mass of the diene rubber may contain 40 to 70 parts by mass of NR and/or IR, 20 to 40 parts by mass of the cobalt type BR and 10 to 30 parts by mass of the neodymium type BR.

The method for producing a tread rubber member according to this embodiment uses carbon black and silica as reinforcing fillers.

The carbon black is not particularly limited and the conventional various kinds can be used. However, a nitrogen adsorption specific surface area (N₂SA) measured according to JIS K6217-2 is preferably 20 to 150 m²/g, more preferably 40 to 120 m²/g and particularly preferably 60 to 120 m²/g. Specific examples of the carbon black include carbon blacks of HAF grade and ISAF grade.

The amount of carbon black added is not particularly limited, but is preferably 30 to 80 parts by mass, more preferably 30 to 70 parts by mass and still more preferably 40 to 70 parts by mass, per 100 parts by mass of the diene rubber

The silica is not particularly limited, but a nitrogen adsorption specific surface area (BET) measured according to BET method defined in JIS K6430 is preferably 80 to 250 m²/g, more preferably 100 to 230 m²/g and still more preferably 120 to 200 m²/g. Wet silica such as wet precipitated silica or wet gelled silica is preferably used.

The amount of silica added is not particularly limited, but is preferably 15 to 50 parts by mass, more preferably 20 to 45 parts by mass and still more preferably 25 to 45 parts by mass, per 100 parts by mass of the diene rubber.

The amount of the reinforcing filler added (the total amount of carbon black and silica) is not particularly limited, and is preferably 10 to 130 parts by mass, more preferably 20 to 100 parts by mass and still more preferably 30 to 80 parts by mass, per 100 parts by mass of the diene rubber.

When silica is added, a silane coupling agent such as sulfide silane or mercaptosilane may further be used. When the silane coupling agent is further used, the amount thereof added is preferably 2 to 20 mass % based on the amount of silica added.

The compound represented by the following formula (I) is used in the method for producing a tread rubber member according to this embodiment.

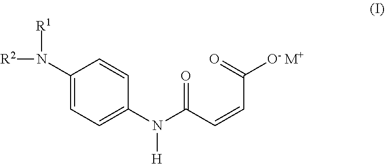

In the formula (I), R¹ and R² represent a hydrogen atom, an alkyl group having 1 to 20 carbon atoms, an alkenyl group having 1 to 20 carbon atoms or an alkynyl group having 1 to 20 carbon atoms, and R¹ and R² may be the same or different.

Examples of the alkyl group in R¹ and R² include methyl group, ethyl group, n-propyl group, isopropyl group, n-butyl group, sec-butyl group and tert-butyl group. Examples of the alkenyl group in R¹ and R² include vinyl group, allyl group, 1-propenyl group and 1-methylethenyl group. Examples of the alkynyl group in R¹ and R² include ethynyl group and propargyl group. Those alkyl group, alkenyl group and alkynyl group have the number of carbon atoms of preferably 1 to 10 and more preferably 1 to 5. R¹ and R² are preferably a hydrogen atom or an alkyl group having 1 to 5 carbon atoms, more preferably a hydrogen atom or methyl group and still more preferably a hydrogen atom. In one embodiment, —NR¹R² in the formula (I) is preferably —NH₂, —NHCH₃ or —N(CH₃)₂ and more preferably —NH₂.

M⁺ in the formula (I) is a sodium ion, a potassium ion or a lithium ion and is preferably a sodium ion.

The amount of the compound represented by the formula (I) added is not particularly limited, but is preferably 0.1 to 10 parts by mass, more preferably 0.5 to 8 parts by mass and still more preferably 1 to 5 parts by mass, per 100 parts by mass of the diene rubber. When the amount of the compound represented by the formula (I) added is 0.1 parts by mass or more, the improvement effect of low heat generation properties is excellent and when the amount added is 10 parts by mass or less, deterioration of tear resistance can be suppressed.

The improvement effect of low heat generation properties is recognized by adding the compound represented by the formula (I). The mechanism is not clear, but is considered as follows.

It is assumed that terminal amine of the compound of the formula (I) is reacted with a functional group on the surface of carbon black and carbon-carbon double bond portion located between an amide group and carboxylic acid salt in the compound of the formula (I) is bonded to a polymer, thereby dispersibility of the carbon black can be improved and this contributes to low heat generation properties.

The method for producing a tread rubber member according to this embodiment can use zinc flower (zinc oxide) conventionally used in a rubber field, without particular limitation, and specific example thereof includes “Zinc Flower #1” manufactured by Mitsui Mining & Smelting Co., Ltd.

The amount of the zinc flower added is not particularly limited, but the amount is preferably 1 to 10 parts by mass, more preferably 1 to 8 parts by mass and still more preferably 1 to 6 parts by mass, per 100 parts by mass of the diene rubber. When the amount of the zinc flower is 1 to 10 parts by mass, workability in kneading the rubber component, carbon black and the compound of the formula (I) is excellent.

The method for producing a tread rubber member according to this embodiment can appropriately contain compounding ingredients generally used in rubber industries, such as a process oil, stearic acid, a softener, a plasticizer, wax, an age resister, a vulcanizing agent and a vulcanization accelerator, in general amounts, in addition to the above-described each component.

Examples of the vulcanizing agent include sulfur components such as powdered sulfur, precipitated sulfur, colloidal sulfur, insoluble sulfur and highly dispersible sulfur. Although not particularly limited, the amount of the vulcanizing agent added is preferably 0.1 to 10 parts by mass and more preferably 0.5 to 5 parts by mass, per 100 parts by mass of the diene rubber. The amount of the vulcanization accelerator added is preferably 0.1 to 7 parts by mass and more preferably 0.5 to 5 parts by mass, per 100 parts by mass of the diene rubber.

The method for producing a tread rubber member according to this embodiment can be performed by kneading the necessary components according to the conventional method using a kneading machine generally used, such as Banbury mixer, a kneader or rolls. Specifically, the method includes a first kneading step of adding carbon black, the compound of the formula (I) and zinc flower to a rubber component, followed by kneading, a second kneading step of adding silica and other additives excluding a vulcanizing agent and a vulcanization accelerator to a first kneaded product obtained by the first kneading step, followed by kneading, and a third step of adding a vulcanizing agent and a vulcanization accelerator to a second kneaded product obtained by the second kneading step, followed by kneading, thereby preparing a rubber composition.

The first kneading step and second kneading step can be conducted using a closed type kneading machine such as Banbury mixer. Each component described above is introduced in a kneading machine, and kneading that is dry mixing having mechanical shear force applied thereto is conducted. When kneaded, a temperature is increased by heat generation due to shearing. Therefore, a kneaded product is discharged from the kneading machine at a predetermined discharge temperature.

The kneading temperature in the first kneading step (for example, discharge temperature from a kneading machine) is not particularly limited, but is preferably 100 to 180° C., more preferably 120 to 180° C. and still more preferably 140 to 170° C. The kneaded product discharged from the kneading machine is generally cooled by being allowed to stand at ordinary temperature.

The kneading temperature in the second kneading step (for example, discharge temperature from a kneading machine) is not particularly limited, but is preferably 100 to 180° C., more preferably 120 to 180° C. and still more preferably 140 to 170° C. The kneaded product discharged from the kneading machine is generally cooled by being allowed to stand at ordinary temperature.

The first kneaded product may not be discharged in the first kneading step, and the first kneading step and the second kneading step may be a series of steps. Furthermore, a remilling step conducting only kneading without adding an additive may be conducted between the first kneading step and second kneading step or between the second kneading step and the third kneading step.

The third kneading step can be conducted using, for example, a kneading machine such as open rolls or Banbury mixer. A vulcanizing agent and a vulcanization accelerator are introduced in the kneading machine together with the second kneaded product obtained in the second kneading machine, followed by kneading, and the resulting kneaded product is discharged from the kneading machine at a predetermined temperature.

The kneading temperature in the third kneading step (for example, discharge temperature from the kneading machine) is preferably 125° C. or lower and more preferably 120° C. or lower.

The rubber composition thus obtained is used as a tread rubber member constituting a ground-contact surface of a tire. The tread rubber includes a tread rubber comprising a two-layered structure of a cap rubber and a base rubber and a tread rubber comprising a single layer structure of those in one body. Because the tread rubber is used as a rubber member constituting a ground-contact surface, when the tread rubber has a single layer structure, a tread part comprises the tread rubber member, and when the tread rubber has a two-layered structure, the cap rubber comprises the tread rubber member.

The tread rubber member is obtained according to the conventional method. For example, the rubber composition is extrusion-molded into a predetermined cross-sectional shape corresponding to a tread part. Alternatively, a ribbon-shaped rubber strip comprising the rubber composition is spirally wound on a drum to form a cross-sectional shape corresponding to a tread part. Thus, an unvulcanized tread rubber member is obtained. The tread rubber member is fabricated into a tire shape together with other tire members constituting a tire, such as an inner liner, a carcass, a belt, a bead core, a bead filler and a sidewall, according to the conventional method. Thus, a green tire (unvulcanized tire) is obtained. The green tire thus obtained is vulcanization-molded at, for example, 140 to 180° C. according to the conventional method. Thus, a pneumatic tire having a tread part comprising the tread rubber member is obtained.

The kind of the pneumatic tire according to this embodiment is not particularly limited, and examples of the pneumatic tire include various tires such as tires for passenger cars and heavy load tires used in trucks, buses and the like.

### EXAMPLES

Examples of the present invention are described below, but the present invention is not construed as being limited to those examples.

Banbury mixer was used. Components excluding a vulcanization accelerator and sulfur were added to a diene rubber according to the formulations (parts by mass) shown in Table 1 below, followed by mixing, in a first kneading step and a second kneading step (discharge temperature: 160° C.). A vulcanization accelerator and sulfur were added to the kneaded product obtained, followed by kneading, in a third kneading step (discharge temperature: 100° C.). Thus, a rubber composition used as a tread rubber member was prepared. In the second kneading step of Comparative Examples 1 to 3, only kneading was conducted without adding additives.

The details of each component in Table 1 are as follows.

SBR: “SBR1502” manufactured by JSR Corporation

BR: “BR 150” manufactured by Ube Industries, Ltd.

NR: RSS#3

Carbon black: HAF grade, “SEAST KIH” (N₂SA=90 m²/g) manufactured by Tokai Carbon Co., Ltd.

Silica: “VN3” (BET-180 m²/g) manufactured by Evonik

Compound (I): Sodium (2Z)-4-[(4-aminophenyl)-amino]-4-oxo-2-butenate (compound represented by the following formula (I′)) manufactured by Sumitomo Chemical Co., Ltd.

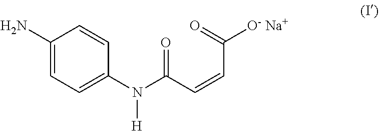

Silane coupling agent: “Si75” manufactured by Evonik

Oil: “NC 140” manufactured by JX Nippon Oil and Sun Energy Corporation

Zinc flower “Zinc Flower #1” manufactured by Mitsui Mining & Smelting Co., Ltd.

Wax: “OZOACE 0355” manufactured by Nippon Seiro Co., Ltd.

Stearic acid: “Industrial Stearic Acid” manufactured by Kao Corporation

Sulfur: “5% Oil-Treated Powdered Sulfur” manufactured by Tsurumi Chemical Industry Co., Ltd.

Vulcanization accelerator 1: “NOCCELER D” manufactured by Ouchi Shinko Chemical Industrial Co., Ltd.

Vulcanization accelerator 2: “SOXINOL CZ” manufactured by Sumitomo Chemical Co., Ltd.

Workability of the first kneading step, tear resistance and low heat generation properties of each rubber composition obtained were evaluated. The evaluation methods are as follows.

Workability of first kneading step: A value obtained by preheating an unvulcanized kneaded product obtained in the first kneading step at 100° C. for 1 minute and then measuring a torque value after 4 minutes in Mooney unit using a rotorless Mooney measuring instrument manufactured by Toyo Seiki Seisaku-Sho according to JIS K6300. The value was indicated by an index as the value of Comparative Example 1 being 100. Mooney viscosity is low as the index is small, and when the value is 110 or less, it shows that workability is excellent.

Tear resistance: Measured according to JIS K6252. Using a sample obtained by punching into a specified crescent shape and making a cut of 0.50±0.08 mm in the center of depression, a test is conducted in a tensile rate of 500 mm/min by a tensile tester manufactured by Shimadzu Corporation. The maximum value of tearing force until a test piece breaks is read. The value is indicated by an index as the result of Comparative Example 1 being 100. When the value is 90 or more, it shows that tear resistance is excellent.

Low heat generation properties: Measured according to JIS K6394. Specifically, loss factor tan δ of a test piece vulcanized at 150° C. for 30 minutes was measured under the conditions of temperature: 60° C., static strain: 10%, dynamic strain: 1% and frequency: 10 Hz by a viscoelasticity testing machine manufactured by Toyo Seiki Seisaku-Sho. The value was indicated by an index as the value of Comparative Example 1 being 100. When the index is 96 or less, it shows that tan δ is small and low heat generation properties are excellent.

TABLE 1

| | | Com. | Com. | Com. | Com. | | |
|---|---|---|---|---|---|---|---|
| | | Ex. 1 | Ex. 2 | Ex. 3 | Ex. 4 | Ex. 1 | Ex. 2 |
| First | SBR | 70 | 70 | 70 | 70 | 70 | 70 |
| kneading | BR | 20 | 20 | 20 | 20 | 20 | 20 |
| step | NR | 10 | 10 | 10 | 10 | 10 | 10 |
| | Carbon black | 75 | 75 | 55 | 55 | 55 | 35 |
| | Silica | — | — | 20 | — | — | — |
| | Compound (I) | — | 2 | 2 | 2 | 2 | 2 |
| | Silane coupling agent | — | — | 1.6 | — | — | — |
| | Oil | 15 | 15 | 15 | — | — | — |
| | Zinc flower | 3 | 3 | 3 | — | 3 | 3 |
| | Wax | 2 | 2 | 2 | — | — | — |
| | Stearic acid | 2 | 2 | 2 | — | — | — |
| Second | Kneaded product 1 | 197.0 | 199.0 | 200.6 | 157.0 | 160.0 | 140.0 |
| kneading | Silica | — | — | — | 20 | 20 | 40 |
| step | Silane coupling agent | — | — | — | 1.6 | 1.6 | 3.2 |
| | Oil | — | — | — | 15 | 15 | 15 |
| | Zinc flower | — | — | — | 3 | — | — |
| | Wax | — | — | — | 2 | 2 | 2 |
| | Stearic acid | — | — | — | 2 | 2 | 2 |
| Third | Kneaded product 2 | 197.0 | 199.0 | 200.6 | 200.6 | 200.6 | 202.2 |
| kneading | Sulfur | 2 | 2 | 2 | 2 | 2 | 2 |
| step | Vulcanization | 1 | 1 | 1 | 1 | 1 | 1 |
| | accelerator 1 | | | | | | |
| | Vulcanization | 1.5 | 1.5 | 1.5 | 1.5 | 1.5 | 1.5 |
| | accelerator 2 | | | | | | |

| | | | | | | |
|---|---|---|---|---|---|---|
| Workability of first kneading step | 100 | 112 | 105 | 130 | 105 | 90 |
| Tear resistance | 100 | 99 | 107 | 97 | 101 | 103 |
| Low heat generation properties | 100 | 98 | 97 | 94 | 95 | 93 |

The results are shown in Table 1. It was recognized in Examples 1 and 2 that tear resistance and low heat generation properties were improved while maintaining and/or improving workability of the first kneading step.

Furthermore, it was recognized in Comparative Example 2 from the comparison with Comparative Example 1 that workability of the first kneading step was deteriorated by the addition of the compound (I). Furthermore, the improvement of low heat generation properties by the compound (1) was insufficient.

From the comparison with Comparative Example 2, the improvement of workability of the first kneading step was recognized in Comparative Example 3 by replacing a part of carbon black with silica and adding the silica, but the improvement of low beat generation properties was still insufficient.

It was recognized in Comparative Example 4 from the comparison with Comparative Example 3 that low heat generation properties were improved while maintaining tear resistance, by kneading the diene rubber, carbon black and the compound (I) in the first kneading step and adding components other than a vulcanization accelerator and sulfur, followed by kneading, in the second kneading step. However, workability of the first kneading step was deteriorated.

### INDUSTRIAL APPLICABILITY

The tread rubber member obtained by the production method of the present invention can be used in various tires of passenger cars, light trucks, buses and the like.

1-4. (canceled)

5. A method for producing a tread rubber member, having:
a step for kneading a diene rubber, carbon black, a compound represented by the following formula (I) and zinc flower, and
a step for adding silica to the kneaded product obtained in the above step, followed by kneading: 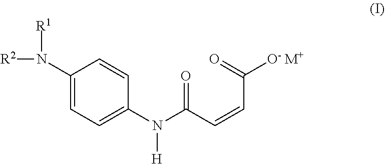
wherein R¹ and R² represent a hydrogen atom, an alkyl group having 1 to 20 carbon atoms, an alkenyl group having 1 to 20 carbon atoms or an alkynyl group having 1 to 20 carbon atoms, R¹ and R² may be the same or different, and M⁺ represents a sodium ion, a potassium ion or a lithium ion.

6. The method for producing a tread rubber member according to claim 5, wherein 30 to 80 parts by mass of the carbon black, 0.1 to 10 parts by mass of the compound represented by the formula (I), 1 to 10 parts by mass of the zinc flower and 15 to 50 parts by pass of the silica are added to 100 parts by mass of the diene rubber.

7. The method for producing a tread rubber member according to claim 5, wherein the content of a styrene-butadiene rubber in the diene rubber is 60 mass % or more.

8. The method for producing a tread rubber member according to claim 6, wherein the content of a styrene-butadiene rubber in the diene rubber is 60 mass % or more.

9. The method for producing a tread rubber member according to claim 5, wherein the carbon black has a nitrogen adsorption specific surface area of 20 to 150 m²/g.

10. The method for producing a tread rubber member according to claim 6, wherein the carbon black has a nitrogen adsorption specific surface area of 20 to 150 m²/g.

11. The method for producing a tread rubber member according to claim 7, wherein the carbon black has a nitrogen adsorption specific surface area of 20 to 150 m²/g.

12. The method for producing a tread rubber member according to claim 8, wherein the carbon black has a nitrogen adsorption specific surface area of 20 to 150 m²/g.

13. The method for producing a tread rubber member according to claim 5, wherein the silica has a nitrogen adsorption specific surface area of 80 to 250 m²/g.

14. The method for producing a tread rubber member according to claim 6, wherein the silica has a nitrogen adsorption specific surface area of 80 to 250 m²/g.

15. The method for producing a tread rubber member according to claim 7, wherein the silica has a nitrogen adsorption specific surface area of 80 to 250 m²/g.

16. The method for producing a tread rubber member according to claim 8, wherein the silica has a nitrogen adsorption specific surface area of 80 to 250 m²/g.

17. A method for producing a tire, comprising producing a tread rubber member by the method for producing a tread rubber member according to claim 5, and producing a tire using the tread rubber member.

18. A method for producing a tire, comprising producing a tread rubber member by the method for producing a tread rubber member according to claim 6, and producing a tire using the tread rubber member.

19. A method for producing a tire, comprising producing a tread rubber member by the method for producing a tread rubber member according to claim 7, and producing a tire using the tread rubber member.

20. A method for producing a tire, comprising producing a tread rubber member by the method for producing a tread rubber member according to claim 8, and producing a tire using the tread rubber member.

21. A method for producing a tire, comprising producing a tread rubber member by the method for producing a tread rubber member according to claim 9, and producing a tire using the tread rubber member.

22. A method for producing a tire, comprising producing a tread rubber member by the method for producing a tread rubber member according to claim 10, and producing a tire using the tread rubber member.

23. A method for producing a tire, comprising producing a tread rubber member by the method for producing a tread rubber member according to claim 13, and producing a tire using the tread rubber member.

24. A method for producing a tire, comprising producing a tread rubber member by the method for producing a tread rubber member according to claim 14, and producing a tire using the tread rubber member.
